(19) United States
(12) Patent Application Publication
(10) Pub. No.: US 2011/0007515 A1
(43) Pub. Date: Jan. 13, 2011

(54) LIGHT-EMITTING DEVICE MOUNTING FIXTURE

(75) Inventor: Todd Farmer, Livermore, CA (US)

Correspondence Address: BridgeLux, Inc., 101 PORTOLA AVENUE, LIVERMORE, CA, 94551, US

(73) Assignee: BRIDGELUX, INC., Livermore, CA (US)

(21) Appl. No.: 12/881,092

(22) Filed: Sep. 13, 2010

Related U.S. Application Data
(60) Provisional application No. 61/335,903, filed on Jan. 12, 2010.

(51) Int. Cl. F21V 21/00; H01R 13/60

(52) U.S. Cl. 362/382; 439/529

(57) ABSTRACT

A light-emitting device mounting fixture comprising a first means for attaching a light-emitting device to the mounting fixture in a defied position, and a second means for attaching the mounting fixture to a heat sink, wherein a distance between the light-emitting device and the location of the second means is determined in accordance with a testing voltage is disclosed. Additionally the disclosed light-emitting device mounting fixture may comprise means for attaching lead wires to electrically conducting contacts, the electrically conducting contacts providing power to the light emitting device to be inserted into the mounting fixture. Furthermore the disclosed light-emitting device mounting fixture may comprise means for disassemble able attachment of a reflector.

### CROSS-REFERENCE TO RELATED APPLICATIONS

This application claims the benefit of U.S. Provisional Patent application Ser. No. 61/335,903 entitled “LIGHT-EMITTING DEVICE MOUNTING FIXTURE” which was filed on Jan. 12, 2010. The entirety of the aforementioned application is herein incorporated by reference.

### BACKGROUND

1. Field

The present disclosure relates to a light-emitting device, and more particularly, to an apparatus for mounting the light-emitting device to a heat sink.

2. Description of Related Technology

A person skilled in the art will appreciate that the concepts disclosed herein are applicable to packages for semiconductor-based light-emitting device, namely a light-emitting diode (LED) device.

LEDs have been used for many years in various light requiring applications, e.g., signaling states for devices, i.e., light on or off, opto-couplers, displays, replacement of bulbs in flashlights, and other applications known in the art. Consequently, LEDs emitting both spectral colors and white light have been developed. Due to LEDs' advantages, i.e., light weight, low energy consumption, good electrical power to light conversion efficiency, and the like, an increased interest has been recently focused on use of LEDs even for high light intensity application, e.g., replacement of conventional, i.e., incandescent and fluorescent light sources, traffic signals, signage, and other high light intensity applications known to a person skilled in the art. It is customary for the technical literature to use the term “high power LED” to imply high light intensity LED; consequently, such terminology is adopted in this disclosure, unless noted otherwise.

To increase intensity of the light emitted by the light-emitting device, often more than one light-emitting die is arranged in a package; such a light-emitting device being termed a light-emitting device array. For the purposes of this disclosure a die has its common meaning of a light-emitting semiconductor chip comprising a p-n junction. Similarly, a package is a collection of components comprising a light-emitting device including but not being limited to: a substrate, a die or dice (if an array), encapsulant, bonding material(s), light collecting means, and the like. A person skilled in the art will appreciate that some of the components are optional.

FIG. 1 depicts a conceptual cross section of an exemplary light-emitting device array 100 in accordance with known concepts. A substantially flat substrate 102 in addition to being a mechanical support for the electrical and optical layers of the light emitting device is often used as a means for heat dissipation from the light-emitting device array. The electrical layers comprise all the components of the package, excluding the substrate 102. When used in the latter function the substrate 102 is made from a material with high thermal conductivity. Such material may comprise metals, e.g., Al, Cu, Si-based materials, ceramics such as AIN, or any other material whose thermal conductivity is appropriate for the light-emitting device array in question. A person skilled in the art will appreciate that material appropriate for a light-emitting device array with power dissipation of, e.g., 35 milliwatts (mW) is different than material appropriate for a light-emitting device array with power dissipation of, e.g., 350 mW. Flatness is understood to describe irregularities whose spacing is greater than the roughness sampling length. A material is considered to be substantially flat if the irregularities in flatness would not cause light to be reflected by such irregularities.

The source of light is a plurality of die 114, disposed on an upper face 104 of the substrate 102. Although four dice 114 are depicted in the cross-sectional FIG. 1, a person skilled in the art will appreciate that such is for an illustration of the concept because the number of dice is a design decision, and different number of dice can be used to satisfy design goals.

To improve light extraction from the light-emitting device array 100, several measures are taken. First, surfaces that are transparent to photons emitted at a particular wavelength or that have poor reflectivity of such photons in an undesirable direction of emission may be treated, e.g., by polishing, buffing, or any other process, to acquire a specific reflectivity. Reflectivity is characterized by a ratio of reflected to incident light. Such surfaces are an upper face 104 of the substrate 102 and inner wall 106 of a support member 108. The support member 108 provides boundary for an encapsulant 110 and reflects light emitted by the dice 114 into desirable direction. Alternatively, the desired reflectivity is achieved by applying a layer of a material with high reflectivity, such as Ag, Pt, and any like materials known to a person skilled in the art, (not shown in FIG. 1) onto such surfaces.

Furthermore, to prevent reflection of the emitted photons from boundaries between materials characterized by different refraction indexes, and, consequently, loss of light intensity, a encapsulant 110 is applied into a cavity 112, surrounding the light-emitting region, i.e., the cavity created by the substrate 102, the support member 108, and the dice 114. The material for the encapsulant 110 is selected to moderate the differences between the refraction indexes of the materials from which components creating the reflective boundaries are made. In one aspect of the disclosure the encapsulant 110 is transparent/clear, however, the disclosed concepts apply equally to encapsulant 110 comprising fillers, e.g., phosphors.

Additionally, light-emitting device array package may further comprise a cover 116 disposed above the dice 114. Such a transparent cover comprises e.g., a window or a lens. In order to prevent delamination of the encapsulant 110 from the surface of the cover 116 and/or the inner wall of the support member 108 and/or the dice 114 and/or the substrate 102, the cover 116 is allowed to float freely on the encapsulant 110, without being rigidly anchored onto the support member 108 with an adhesive or another fastening means. Such a configuration prevents significant residual stress, caused by temperature variation as the light-emitting device array 100 heats and cools during the device's lifetime, to develop within the encapsulant 110. Because any delamination would introduce voids in the encapsulant, the resulting internal reflection optical losses caused by the above-described difference between materials characterized by different refraction indexes would cause loss of light intensity.

Although the configuration depicted in FIG. 1 may be suitable for LED packages comprising a clear cover, it is not particularly suitable for LED package comprising a window or lens coated with or filled with phosphors; such a cover being often used for light conversion. An advantage of such a configuration is that the window or lens coated with or filled with phosphors can be matched appropriately with a LED dice of known wavelength to achieve a more precisely controlled color corrected temperature (CCT). Different windows or lenses may have different phosphor coatings or fillings, and these matched with LED dice of optimal wavelength to achieve target CCT as needed.

However, a problem with this configuration arises from the fact that the temperature of the phosphor coated or filled cover increases significantly during operation of the light-emitting device array because the conversion inefficiency of the phosphors results in generating significant heat. The increase in the temperature in turn results in decreased efficiency of the light-emitting device array due to the decrees in light-conversion efficiency of the phosphors and decrease of efficiency of the die.

The above-described problem may be solved by a configuration according to FIG. 2, which depicts a conceptual cross section of another exemplary light-emitting device array 200 in accordance with known concepts. The description of like elements between FIG. 1 and FIG. 2 is not repeated, the like elements have reference numerals differing by 100, i.e., reference numeral 102 of FIG. 1 becomes reference numeral 202 in FIG. 2.

Referring to FIG. 2, the main conceptual difference from FIG. 1 is that a cover 216 coated with or filled with phosphors is attached to the upper face 218 of the thermally conductive support member 208. The bottom face 220 of the support member 208 is attached to a thermally conductive substrate 202. Thus, in this aspect, the support member further serves as supporting means for the cover 216. The cover 216, the support member 208, and the substrate 202 should be attached to one another using any thermally conductive means (not shown in FIG. 2) to maximize heat transfer between these components. By the means of example, such a thermally conductive means may comprise material such as metal filled epoxy, eutectic alloy, and any other thermally conductive means known to a person skilled in the art. Furthermore, it is desirable that the cover 216 is also made from a thermally conductive martial. Such a configuration allows heat to flow from the phosphors through the window or the lens 216 and then through the support member 208 to the substrate 202.

Since additional heat from the cover 216 is now transferred to the substrate 202, proper heat dissipation from the LED package 200 must be assured to prevent loss of efficiency due to increased temperature of the dice 114. Such heat dissipation may be achieved by proper design of the above-described components of the LED package 114. In addition, the LED package 200 may further be attached to a suitable heat sink (not shown).

In any of the above-described configurations, the LED package 200 can operate without the phosphors or the LED dice over-heating beyond temperature that would significantly decrease the efficiency of the LED dice and the phosphors. A person skilled in the art will appreciate that the term significant describes a decrease in efficiency that would cause the light-emitting device array performance fail to meet typical or minimum specification over the product life of the light-emitting device array.

The LED array is subject to various safety testing requirements, prescribed by different authorities, i.e., Underwriter Laboratories, Conformité Européne, and the like. In some of the testing procedures the LED array must withstand high potential of, e.g. 4000V applied between the substrate and the heat sink, on which the LED array is mounted. The mounting fixtures/practices in accordance with known concepts, depicted in FIG. 3 may create insufficient insulation between the substrate and the heat sink, causing the LED array to fail the test.

Referring to FIG. 3, an LED array 300 (such an exemplary LED array according to FIG. 1 or FIG. 2) is mounted on a heat sink 304. In order to electrically insulate the substrate 302 from the heat sink 304, an intermediate layer 306 is disposed between the substrate 302 and the heat sink 304. The intermediate layer 306 comprises a material with high thermal conductivity and high electrically insulating property, e.g., silicon paste, silicon pad or other materials known to a person skilled in the art. The attachment is provided by a plurality of screws 308 (two screws 308(1) and 308(2) shown) fitting into a plurality of slots 310 in the substrate 302. However, because the screws 308 penetrate the intermediate layer 306, a path for an electric arc can be created between the substrate 302 and the heat sink 304, causing the LED array to fail the test.

Should the LED device fail the test, the manufacturer is required to use an isolated driver instead of non-isolated driver to power the LED device. An isolated driver provides insulation between the primary power, e.g., a wall plug, and the secondary power providing power to the LED device. A non-isolated driver does not comprise such insulation. Because the isolated driver is more expensive than the non-isolated driver, the failed test results in higher assembly costs.

In accordance with known concepts, the wire leads from the driver are attached to the LED device by soldering to solder pads provided on the LED device. Because the solder pads must be accessible for soldering, solder pads create danger of being contacted during manipulation with the LED device and, consequently, causing potential electrical shock.

Using screws to attach a substrate to a heat sink has further disadvantage in that it is laborious operation both from a manufacturing and a serviceable point of view, thus increasing cost both to manufacturers and end consumers.

Additionally, some LED devices comprise a light collecting means, e.g., a reflector to concentrate light emitted by the LED devices into desirable direction. In accordance with known concepts, the reflector is attached by gluing. The design on the LED device must accommodate a reflector of a particular shape, often defined by included angle, and once attached, it is not easily, if at all, replaceable.

Accordingly, there is a need in the art for a mounting fixture for a light-emitting device providing solution the above identified problems, as well as additional advantages evident to a person skilled in the art.

### SUMMARY

In one aspect of the disclosure, a mounting fixture for a light-emitting device according to appended independent claims is disclosed. Preferred additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual cross section of an exemplary light-emitting device array in accordance with known concepts;

FIG. 2 depicts a conceptual cross section of another exemplary light-emitting device in accordance with known concepts;

FIG. 3 depicts an exploded view of a conceptual assembly of an exemplary light-emitting device array and a heat sink in accordance with known concepts;

FIG. 4 depicts an view of a conceptual configuration of a mounting fixture in accordance with an aspect of this disclosure;

FIG. 5 depicts an exploded view of a conceptual assembly of an exemplary light-emitting device array and a heat sink in accordance with an aspect of this disclosure;

FIG. 6 depicts an exploded view of a conceptual configuration of an exemplary mounting fixture comprising means for attaching wire leads from a driver to a LED device in accordance with an aspect of this disclosure;

FIG. 7 depicts an exploded view of a conceptual drawing of a reflector in accordance with an aspect of the disclosure;

FIG. 8 depicts an exploded view of a conceptual drawing of an exemplary mounting fixture comprising attachment means enabling disassemble able attachment of the reflector from FIG. 7;

FIG. 9 depicts an exploded view of a conceptual assembly of a reflector from FIG. 7 and attachment means from FIG. 8; and

FIG. 10 depicts an exploded view of a conceptual assembly of an exemplary light-emitting device array and a heat sink in accordance with aspects of this disclosure.

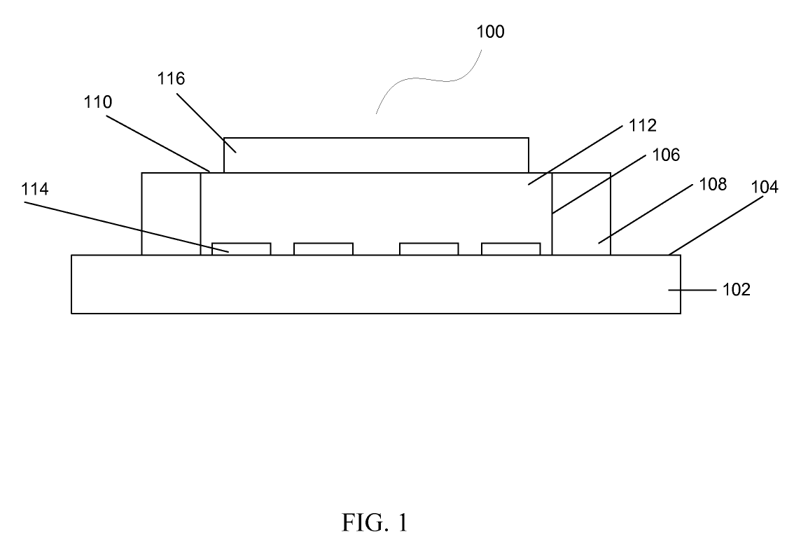

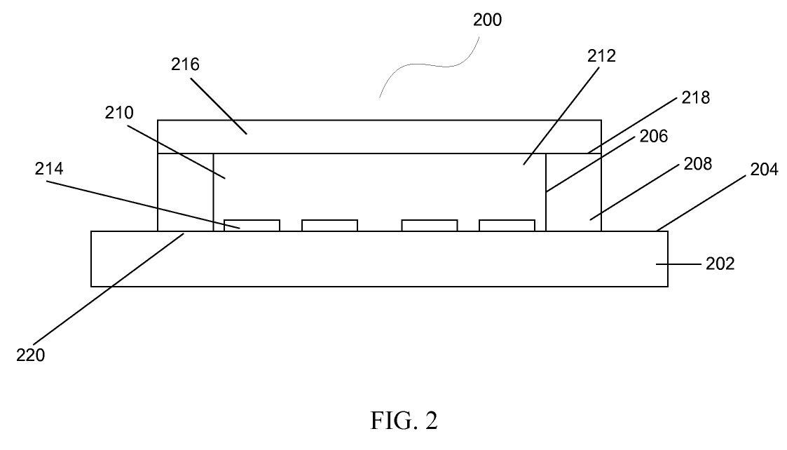

### DETAILED DESCRIPTION

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements disclosed as being on the “lower” side of other elements would then be oriented on the “upper” side of the other elements. The term “lower” can therefore encompass both an orientation of “lower” and “upper,” depending on the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Furthermore, various descriptive terms used herein, such as “on” and “transparent,” should be given the broadest meaning possible within the context of the present disclosure. For example, when a layer is said to be “on” another layer, it should be understood that that one layer may be deposited, etched, attached, or otherwise prepared or fabricated directly or indirectly above or below that other layer. In addition, something that is described as being “transparent” should be understood as having a property allowing no significant obstruction or absorption of electromagnetic radiation in the particular wavelength (or wavelengths) of interest, unless a particular transmittance is provided.

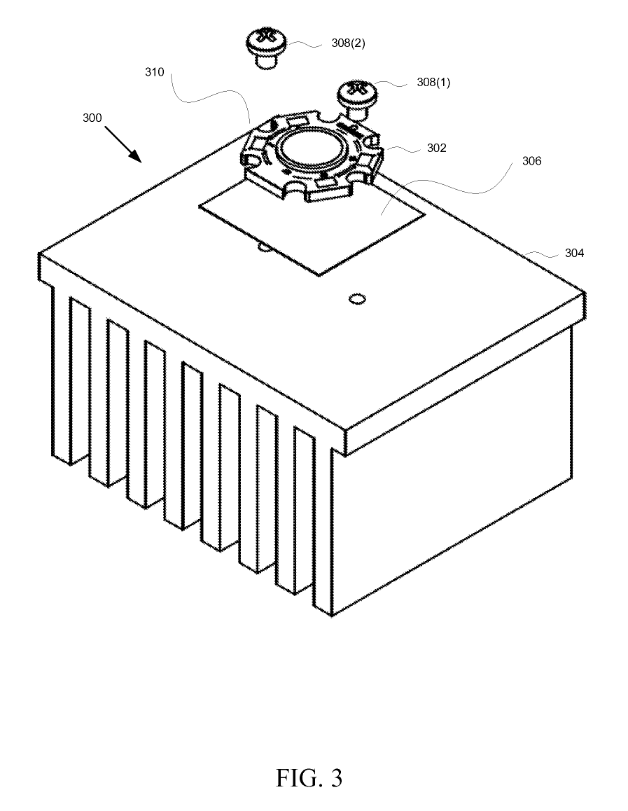

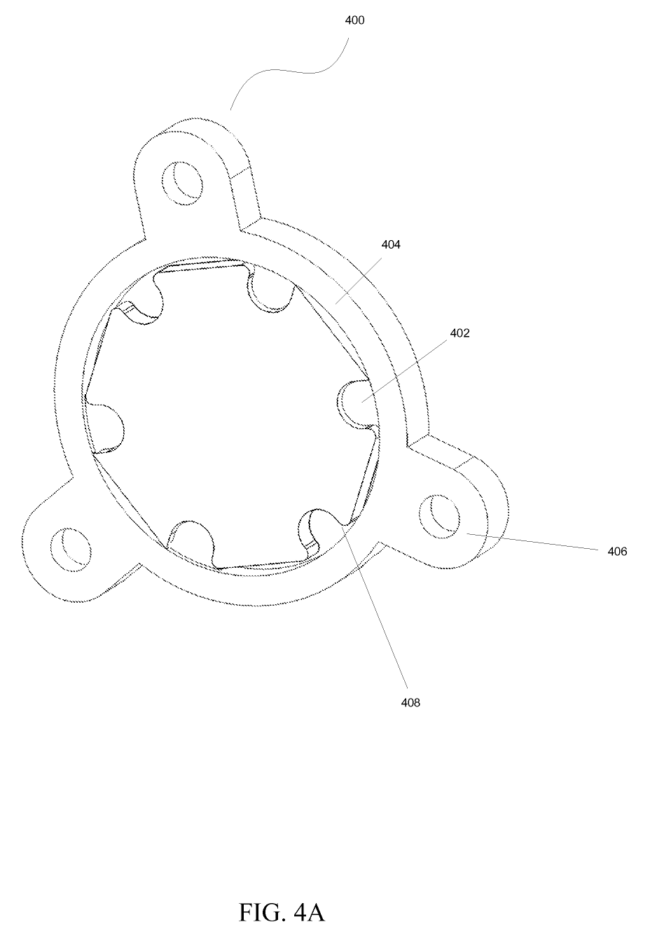

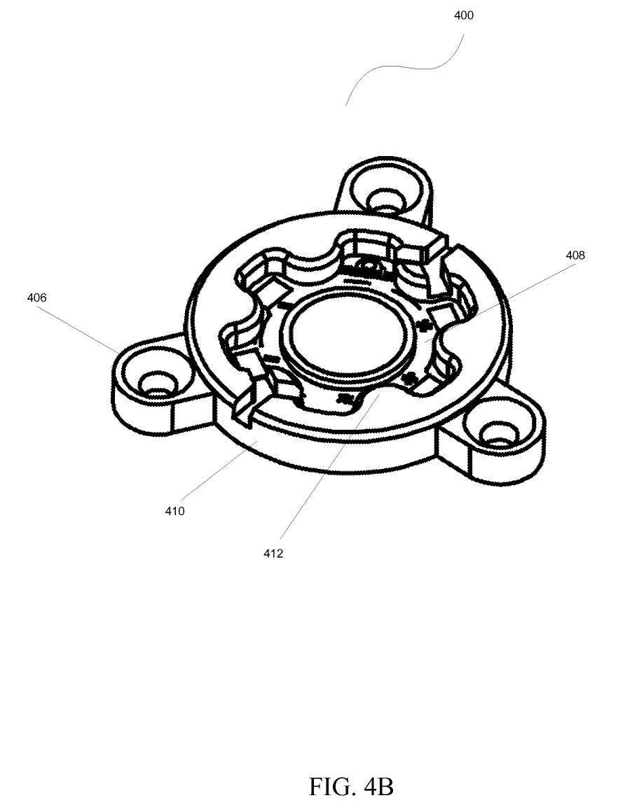

FIG. 4 depicts an exploded view of a conceptual configuration of a mounting fixture 400 in accordance with an aspect of this disclosure, wherein FIG. 4a depicts a bottom view and FIG. 4b a top view. The mounting fixture comprises means for attaching the mounting fixture 400 to an LED device 408. Such an LED device may be, e.g., an LED device as depicted in FIG. 3. The illustrated particular embodiment of the attachment means comprises a plurality of protrusion 402 matching in shape the plurality of slots 310 in the substrate 302 of the LED device from FIG. 3. In one aspect, the tolerance of surfaces of the matching slots—protrusions is such that a fit which enables the LED device 408 to be inserted in and removed from the mounting fixture 400 without tools, but preventing the LED device 408 from falling from the mounting fixture 400 during subsequent manipulation. A person skilled in the art will appreciate that although a particular configuration of means of achieving fit attachment between a mounting fixture 400 and a LED device 408 has been described, other means known in the art are within the scope of the disclosed aspect. Such means may comprise, e.g., screwed, clamped, and glued attachment. A person skilled in the art will further appreciate that because the shape of the LED device 408 and, consequently the mounting fixture 400 is a design criterion, other shapes that the circular shape depicted are within the scope of the disclosed aspect.

In one aspect of the disclosure, the bottom face 404 of the mounting fixture 400 and the bottom face of the substrate 302 from FIG. 3 are aligned to be substantially level and flat, i.e., the irregularities in level and flatness would not cause gaps between the bottom face of the substrate 302 from FIG. 3 and an intermediate layer when the mounting fixture 400 substrate 302 from FIG. 3 assembly is attached to a heat sink.

Alternatively, the bottom face of the substrate 302 from FIG. 3 is recessed, i.e., disposed below the bottom face 404 of the mounting fixture 400 by a dimension allowing for dimensional distortion of the intermediate layer due to a pressure exerted on the intermediate layer when the mounting fixture 400 substrate 302 from FIG. 3 assembly is attached to a heat sink. Such an arrangement ensures consistent pressure among the components.

The means for achieving the above-described alignment comprises a plurality of protrusions 412 formed in the body 410 of the mounting fixture 400 which act as stops preventing the LED device 408 to slide through the opening in the body 410. The high of the plurality of protrusions 412 establishes either the substantially level and flat or the recessed alignment.

To accommodate attachment of the mounting fixture 400 substrate 302 from FIG. 3 assembly to a heat sink, the mounting fixture 400 comprises attachment means. In one aspect of the disclosure, depicted in FIG. 4, the means comprises a plurality of semi-circular flanges 406 for locating screws, the means being located at a distance away from the outside of the substrate 302 from FIG. 3. A person skilled in the art will appreciate that other shape of the flanges 406, or a continuous flange, are within the scope of the disclosed aspect. The distance between the outside of the substrate 302 from FIG. 3 and the location of the screws is determined in accordance with a testing voltage and an applicable standard. As a means of an example, the UL test standard recommends an air-gap distance as a function of applied voltage, e.g., 6 mm air-gap distance for 1240 volts.

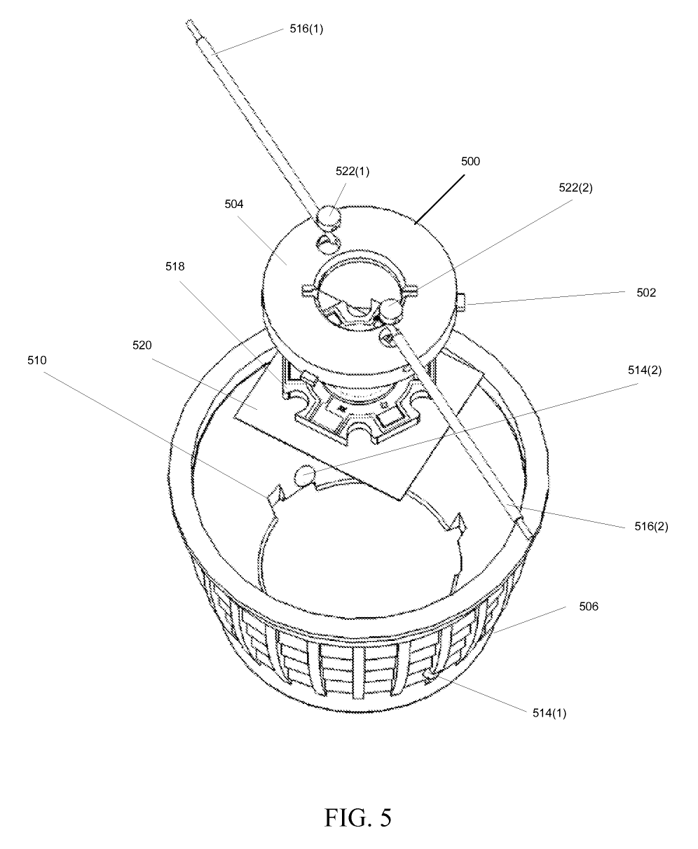

In an alternative aspect of the disclosure depicted in FIG. 5, the mounting fixture 500 comprises attachment means depicted as a plurality of locking posts 502, perpendicular to the side wall 504. A person skilled in the art will appreciate that although the locking posts 502 are depicted as flange-shaped, other shapes, e.g., pins, allowing for the below described locking action are within the scope of the disclosed aspect.

A heat sink 506 comprises attachment means enabling screw less attachment of the mounting fixture 500 to the heat sink 506. A diameter of an opening 508 is dimensioned to accept the mounting fixture 500. A plurality of slots 510, matching the plurality of locking posts 502, is introduced into the heat sink 506. The plurality of slots 510 does not extent through the height of the heat sink 506, but ends in second plurality of slots 512, matching the plurality of slots 510, introduced into the heat sink 506. The second plurality of slots 512 starts on the bottom of the plurality of slots 510 and is parallel with or tilted downwards towards the bottom of the heat sink 506.

To attach the mounting fixture 500 to the heat sink 506, the plurality of locking posts 502 are aligned with the plurality of slots 510 and the mounting fixture 500 is disposed into the opening 510. When the locking posts 502 reach the bottom of the slots 510 the mounting fixture 500 is twisted in the direction of the plurality of slots 512. The friction between the plurality of locking posts 502 and the plurality of slots 512 keeps the mounting fixture 500 to the heat sink 506.

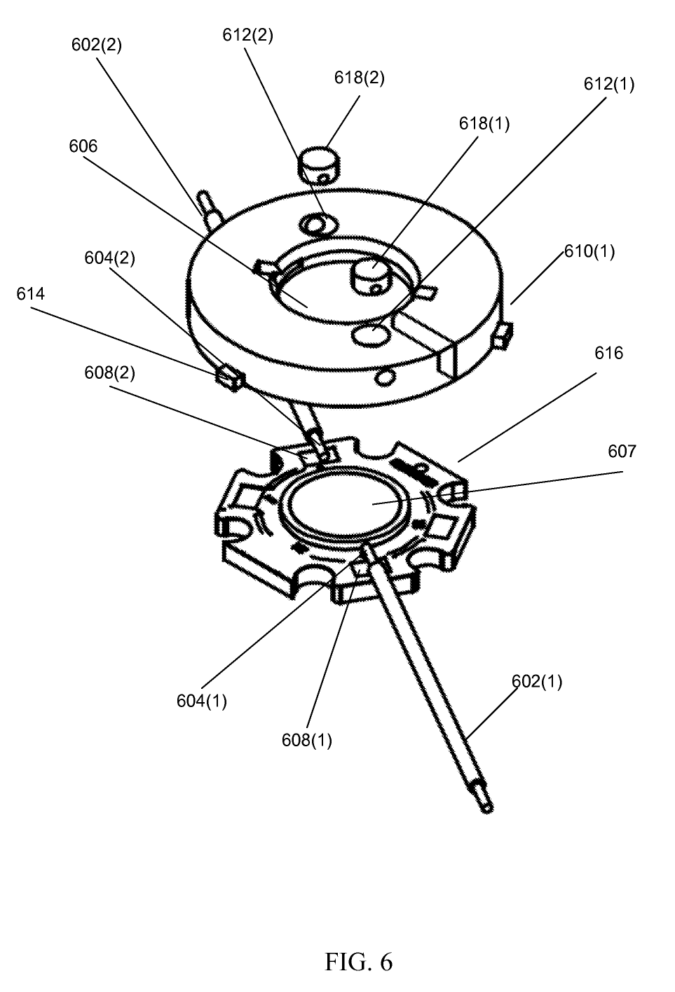

A plurality of openings 514 (two openings 514(1), 514(2) shown), are introduced into the heat sink 506, to allow wire leads 516(1), 516(2) to reach the mounting fixture 500 and be attached to a LED device 518. As depicted a screw less attachment as disclosed in reference to FIG. 6 and associated text, two electrically non-conducting caps 522(1), 522(2) are also shown in FIG. 5.

Referring now to FIG. 6, the mounting fixture 600 further comprises means for attaching wire leads 602, from a driver (not shown) to the LED device 600 without the need of soldering and further without exposing non-insulated part 604 of the wire leads 602 to touch. As depicted, the opening 606 in the mounting fixture 600 is dimensioned to accommodate the electrical an optical layers 607. Consequently, the mounting fixture 600 extends above at least two attachment points 608 (two attachment points 608(1), 608(2) shown), of the LED device 600. The attachment points 608 comprise a soldering pad or any other means for providing electric power to the electrical and optical layers 607. At least two openings 610 (two openings 610(1), 610(2) shown), are introduced into the mounting fixture 600 extending above the attachment point 608. The openings 610(1), 610(2) can extent throughout the thickness of the mounting fixture 600 or, alternatively, be blind on the inside of the mounting fixture 600. Another at least two openings 612 (two openings 612(1), 612(2) shown), are introduced into the mounting fixture 600 connecting the inside of the openings 610(1), 610(2) with the bottom face 614 of the mounting fixture 600. When the LED device 616 is inserted in the mounting fixture 600 an eclectically conducting contact 618 is in contact with the attachment point 608(1) and protrudes into the opening 610(1). The wire leads 602 from a driver (not shown) to the LED device 616 inserted into the at least two openings 610(1), 610(2) attach to the protruding end of the eclectically conducting contact 618.

A person skilled in the art will appreciate that the above-described attachment means can be implemented in many alternatives known from respective related technologies. By means of an example, the eclectically conducting contact 618 can be attached to the attachment point 608, e.g., by soldering. The attachment between the wire leads (not shown) and the protruding end of the electrically conducting contact 618 can then be implemented by inserting the wire leads 602 into the at least two openings 610(1), 610(2) and pinning the wire leads between the opening 610 and the eclectically conducting contact 618 by inserting the LED device 616 in the mounting fixture 600. By means of another example, the electrically conducting contact 618 can be disposed into the at least two openings 612(1), 612(2) and come into contact with the attachment point 608 by inserting the LED device 616 in the mounting fixture 600. The attachment between the wire leads 602 and the protruding end of the electrically conducting contact 618 can then be implemented by inserting the wire leads 602 into the at least two openings 610(1), 610(2) thus pinning the wire leads between the opening 610 and the electrically conducting contact 618. The conducting contact 618 is enclosed by an electrically non-conducting cap 620 (not shown); consequently, the conducting contact 618 is not exposed to touch.

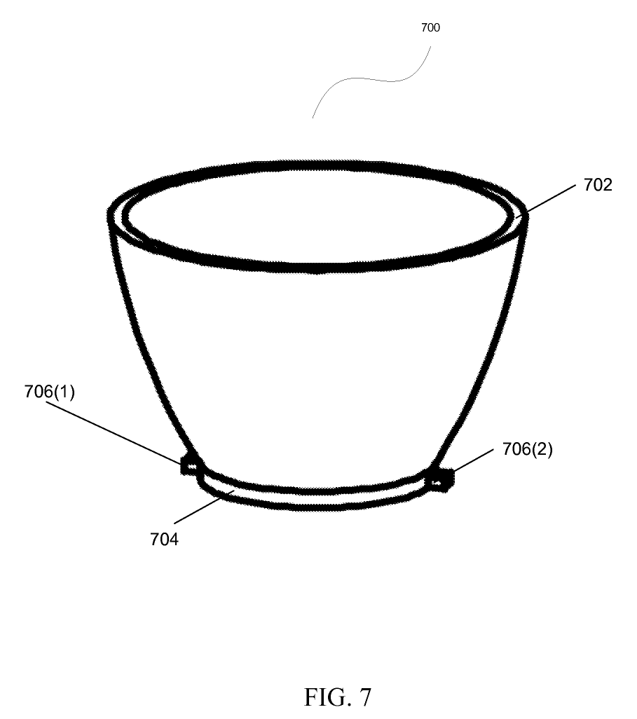

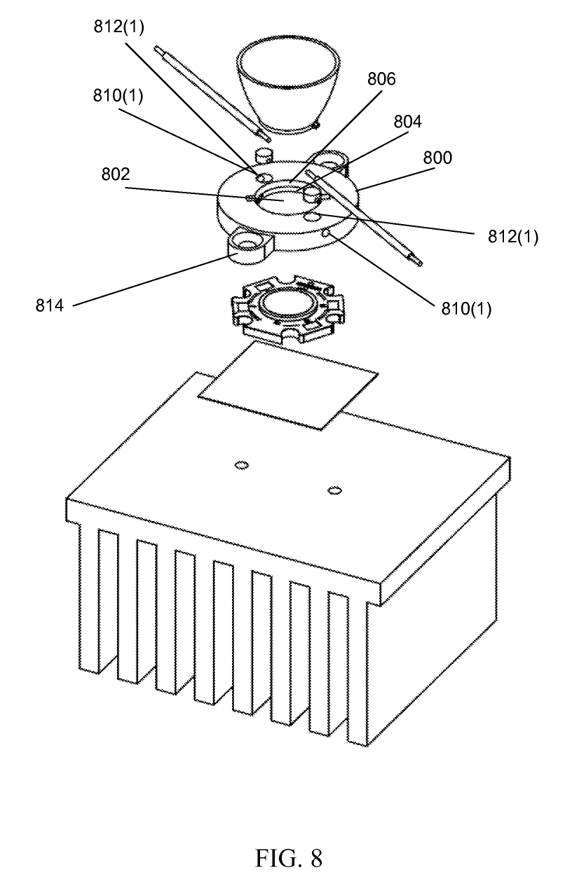

FIG. 7 depicts a conceptual drawing of a reflector 700 in accordance with an aspect of the disclosure. The reflector 700 comprises a body 702 and a flange 704. A plurality of locking posts 706, perpendicular to the bottom flange serve as attachment means to a mounting fixture 800 depicted in FIG. 8. A person skilled in the art will appreciate that although the locking posts 706 are depicted as flange-shaped, other shapes, e.g., pins, allowing for the below described locking action are within the scope of the disclosed aspect.

FIG. 8 depicts a conceptual drawing of a mounting fixture 800 comprising attachment means enabling disassemble able attachment of the reflector 700 from FIG. 7 to the mounting fixture 800. The opening 802 is dimensioned both as to the diameter and the height of the face 804 to accept the bottom flange 704 from FIG. 7. Above the height of the face 804, the opening 802 is relieved with an included angle greater than the greatest included angle of the reflector body 702 from FIG. 7, creating a face 806, thus enabling the mounting fixture 800 to be used without modification with reflectors with different included angles. A plurality of slots 808 (matching the plurality of locking posts 706 from FIG. 7) is introduced into the mounting fixture 800. The plurality of the slots 808 does not extent through the height of the mounting fixture 800. A second plurality of slots 810 (matching the plurality of the slots 808) is introduced into the mounting fixture 800. The second plurality of slots 810 starts on the bottom of the plurality of slots 808 and is parallel with or tilted downwards or upwards in reference to the bottom of the mounting fixture 800.

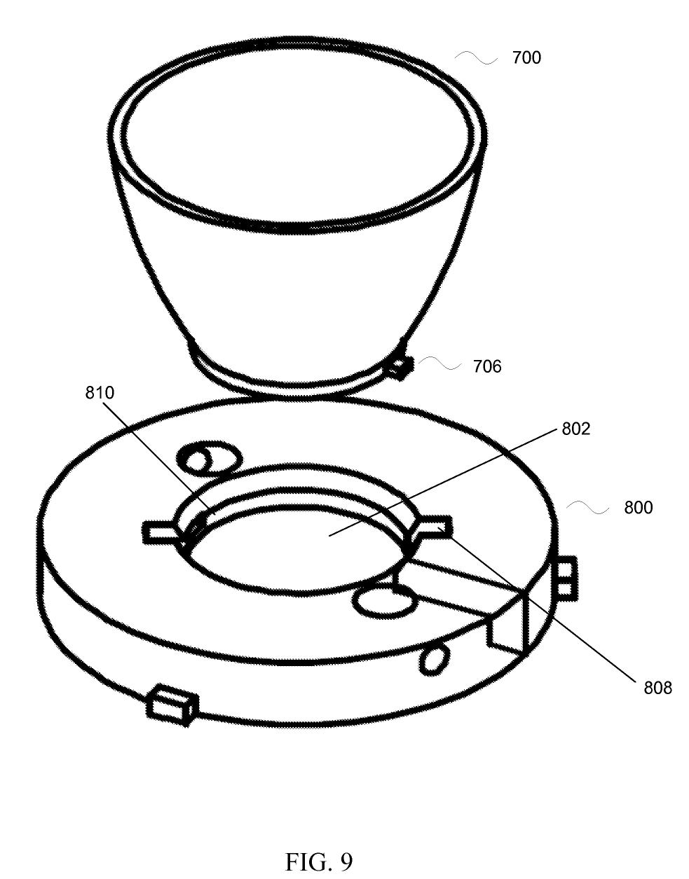

Referring now to FIG. 9, which for clarity retained the references from FIG. 7 and FIG. 8, to attach the reflector 700 to the mounting fixture 800, the plurality of locking posts 706 are aligned with the plurality of slots 808 and the reflector flange 704 is disposed into the opening 802. When the locking posts 706 reach the bottom of the slots 808 the reflector is twisted in the direction of the slots 810. The friction between the plurality of locking posts 706 and the plurality of slots 810 keeps the reflector 700 attached to the mounting fixture 800.

A person skilled in the art will appreciate that the different aspects disclosed in reference to a particular figure and an associated text are not to be considered as applicable only to the particular figure and the associated text, but can be combined to result in a mounting fixture best suited for a given design goal. Consequently, a particular mounting fixture may, but does not have to comprise all the different aspects disclosed. Thus, by means of an example, if a mounting fixture is to be used with a LED device comprising soldering pads, it may be difficult or costly to design solder free wire leads connection. However, other disclosed aspects, e.g., screw free attachment of the mounting fixture to a heat sink, disassemble able attachment of a reflector to the mounting fixture and/or other disclosed aspects can be incorporated in the final design of the mounting fixture. Furthermore, a screw free attachment of the mounting fixture to a heat sink will not work if a design goal requires the heat sink to be flat; cf., FIG. 3 with FIG. 5.

By means of a particular example refer back to FIG. 8, showing an aspect of a disassemble able attachment of a reflector 700 from FIG. 7, to the mounting fixture 800, but comprises at least two slots 810 (two openings 810(1), 810(2) shown), for lead wires (not shown) ending in matching plurality of openings 812 through which the lead wires are soldered to an attachment point (not shown) on a substrate (not shown). Furthermore, the mounting fixture 800 comprises openings 814(1), 814(2) for locating screws (not shown) designed in accordance with aspects disclosed in reference to FIG. 4 and related text, because the fixture is intended to be mounted on a flat heat sink.

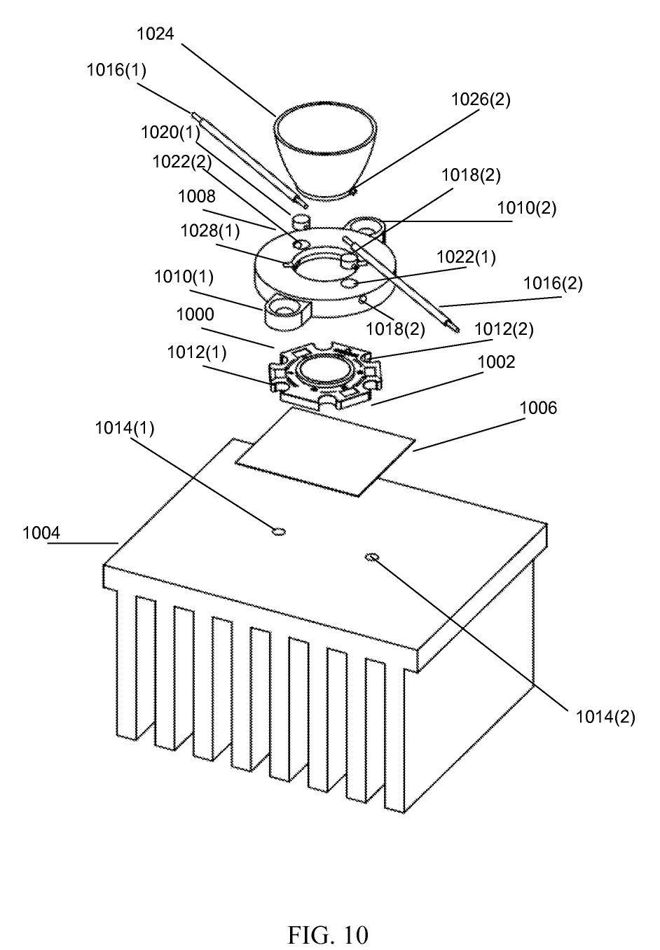

FIG. 10 depicts an exploded view of a conceptual assembly of an exemplary light-emitting device array 1000 and a flat heat sink 1004 in accordance with aspects of this disclosure. In order to electrically insulate the LED array substrate 1002 from the heat sink 1004, an intermediate layer 1006 is disposed between the substrate 1002 and the heat sink 1004. The intermediate layer 1006 comprises a material with high thermal conductivity and high electrically insulating property, e.g., silicon paste, silicon pad or other materials known to a person skilled in the art. A mounting fixture 1008 (such as a mounting fixture according to FIG. 4 or FIG. 8 and associated text) is used to attach the LED array 1000 to the heat sink 1004. The attachment is provided by a plurality of screws (not shown) fitting into a plurality of semi-circular flanges 1010 (two flanges shown). The plurality of screws passes through a plurality of slots 1012 in the substrate 1002 and is threaded into a plurality of holes 1014 in the heat sink 1004. Wire leads 1016 from a driver (not shown) are attached to the LED array 1000 in accordance with aspects disclosed herein. (See, e.g., FIG. 5 or FIG. 6 and associated text). As shown, the wire leads 1016 are inserted into the openings 1018 and attach to the protruding end of the electrically conducting contacts 1020 inserted into the at least two openings 1022. As shown, a reflector 1024 is attached to the mounting fixture 1008 by means of a plurality of locking posts 1026 aligned with plurality of slots 1028.

The various aspects of this disclosure are provided to enable one of ordinary skill in the art to practice the present invention. Modifications to various aspects of the aspects presented throughout this disclosure will be readily apparent to those skilled in the art, and the concepts disclosed herein may be extended to other applications. Thus, the claims are not intended to be limited to the various aspects of the reflective surfaces for a light-emitting device array presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A light-emitting device mounting fixture comprising:
a first means for attaching a light-emitting device to the mounting fixture, the first means defining position of the light-emitting device substrate within the mounting fixture; and
a second means for attaching the mounting fixture to a heat sink;
wherein a distance between the light-emitting device substrate and the location of the second means is determined in accordance with a testing voltage and a standard.

2. The apparatus according to claim 1, wherein the second means comprises a plurality of openings for locating screws formed in a flange of the mounting fixture.

3. The apparatus according to claim 2, wherein the flange of the mounting fixture comprises a continuous flange.

4. The apparatus according to claim 2, wherein the flange of the mounting fixture comprises a plurality of flanges.

5. The apparatus according to claim 1, wherein the second means comprises a plurality of locking posts formed on the mounting fixture.

6. The apparatus according to claim 5, wherein the plurality of locking posts formed on the mounting fixture comprises a male part of a bayonet twist mount.

7. A light-emitting device mounting fixture comprising:
at least two first openings configured to accept lead wires; and
at least two second openings configured to accept electrically conductive contacts;
wherein the at least two first openings and the at least two second openings are arranged so that when the lead wires are inserted into the at least two first openings and the electrically conductive contacts are inserted into the at least two second openings then the lead wires and the electrically conductive contacts attach.

8. The apparatus according to claim 7, further comprising:
means for attaching a light-emitting device to the mounting fixture, the means defining position of the light-emitting device within the mounting fixture;
wherein the location of the at least two second openings with respect to the means is such that the at least two second openings would be located above the light-emitting device attachment points providing electric power to the electrical and optical layers of the light-emitting device were the light-emitting device attached to the mounting fixture.

9. The apparatus according to claim 7, wherein the at least two first openings comprise at least two holes introduced through a body of the mounting fixture.

10. The apparatus according to claim 7, wherein the at least two first openings comprise at least two slots introduced into a body of the mounting fixture.

11. The apparatus according to claim 7, further comprising:
at least two electrically non-conductive caps configured to be inserted into the at least two second openings.

12. A light-emitting device mounting fixture comprising:
a cylindrical opening perpendicular to a bottom of the mounting fixture;
a first plurality of slots introduced axially into the wall of the cylindrical opening; and
a second plurality of slots introduced into the wall of the cylindrical opening;
wherein the second plurality of slots starts on the bottom of the first plurality of slots and is parallel with or tilted in regards to the bottom of the mounting fixture

13. The apparatus according to claim 12, wherein the cylindrical opening, the first plurality of clots and the second plurality of slots comprises a female part of a bayonet twist mount.

14. The apparatus of claim 12, further comprising:
a conical relief in the cylindrical opening.

15. The apparatus of claim 14, wherein the included angle of the conical relief in the cylindrical opening is greater than a pre-determined angle.
